(19) United States
(12) Patent Application Publication
(10) Pub. No.: US 2007/0041016 A1
(43) Pub. Date: Feb. 22, 2007

(54) Method of processing signals obtained from scanning textile fabrics

(75) Inventors: Ian George, Cambridge (GB); Sandra Edalat-Pour, Hadlikon (CH); Karl-Ludwig Schinner, Diessen (DE)

Correspondence Address: BUCHANAN, INGERSOLL & ROONEY PC, POST OFFICE BOX 1404, ALEXANDRIA, VA, 22313-1404, US

(73) Assignee: Uster Technologies AG, Uster (CH)

(21) Appl. No.: 10/575,851

(22) PCT Filed: Oct. 7, 2004
(86) PCT No.: PCT/CH04/00613

§ 371 Date: Jul. 13, 2006

(30) Foreign Application Priority Data
Oct. 16, 2003 (CH) 176/03

(51) Int. Cl. G01N 21/84; G01N 21/88

(52) U.S. Cl. 356/430; 356/238.2

(57) ABSTRACT

The invention relates to a method of processing signals obtained from scanning textile fabrics (1). To provide a method which makes it possible to evaluate the faults (4, 5, 6) in a fabric in a highly differentiated way and which results in targeted actions on the basis of the faults that are recognised, first of all, for values of parameters, value ranges which define categories of faults in the fabric are determined. For categories of faults in the fabric, the distribution of faults in the fabric is then to be determined and, as a function-of the category determined and the distribution of the faults in the fabric, an action is to be performed in connection with the fabric.

The invention relates to a method of processing signals obtained from scanning textile fabrics.

EP 1 100 989 discloses for example a method of evaluating faults in textile fabrics by means of which the permissibility of faults in fabrics is determined on the basis of the length and contrast of the faults by comparison with the fault-free fabric. Here, the longer the fault and the greater the contrast, the more probable it is that the fault concerned is undesirable. The same actions are then always provided for each fault which is recognised as such and is undesirable, or in other words unacceptable. That means that an undesirable fault in a textile fabric has the result that the fault is removed if possible or the relevant part of the fabric is sold at a lower price or is not sold at all, and hence becomes a reject.

One disadvantage of this-known method can for example be seen in the fact that a sharp line is drawn between permissible and impermissible faults. This line or limit is selected by weighting opposing factors such as the economics and the quality of the fabric. To guarantee economics, the limit should be selected such that as few faults as possible result in rejects. To guarantee quality, as far as possible all faults should be recognised as such and indeed removed, or the fabric must be counted among the rejects. These opposing factors result in the decision on permissible or impermissible faults becoming a compromise which is undifferentiated and difficult to find.

It is therefore an object of the present invention as characterised in the claims to provide a method which makes it possible to evaluate the faults in a fabric in a highly differentiated way and which results in targeted actions on the basis of the faults that are recognised.

This object is achieved in that signals produced when textile fabrics are scanned are used to derive values for defined parameters such as contrast, intensity, length, direction and so on. Limit values which are used to determine faults in the fabric are also predetermined for the parameter values. Value ranges which define categories of faults in the fabric are determined for the faults, that is to say the parameters characterising them. For each category of fault in the fabric, the distribution of faults in the fabric is determined and where necessary, as a function of the category and distribution of the faults in the fabric, an action to be performed on the fabric is triggered, such as counting the faults, stopping the drive for the fabric, triggering an alarm, ignoring the faults or marking the faults.

The advantages achieved by the invention can be seen in particular in the fact that both the economics of manufacturing a fabric and the quality of the fabric can be improved thereby in that the faults and their distribution result in actions which are highly dependent on how detrimental the faults actually are to use of the fabric in concrete terms. This means that the evaluation of the fabrics can be adapted to all possible circumstances in a very precise and highly differentiated way.

The invention will be explained below in more detail with reference to an example embodiment and to figures, in which:

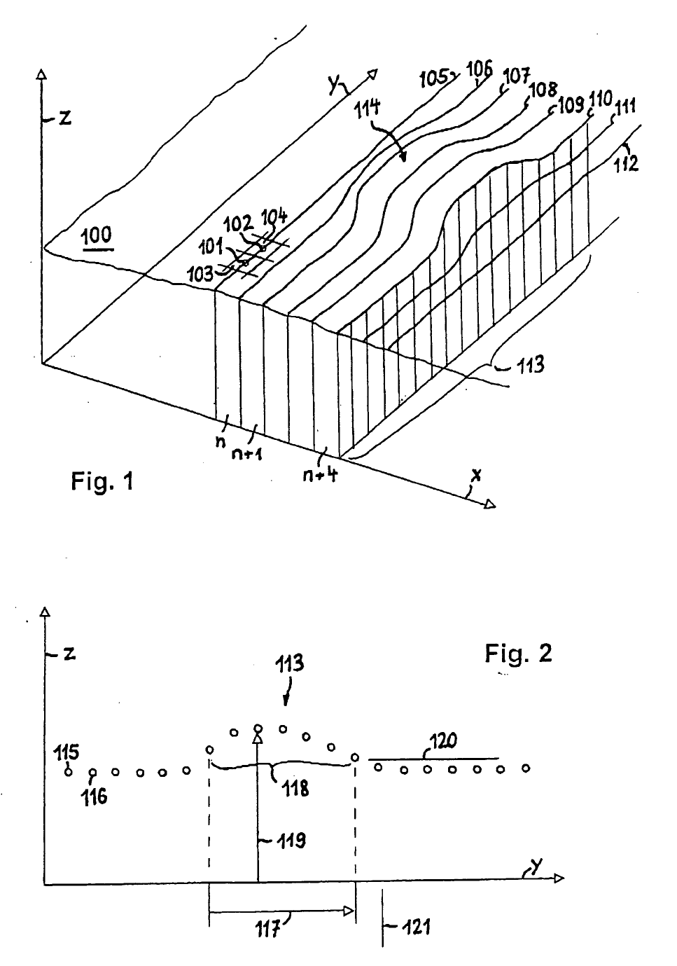

FIGS. 1 and 2 each show part of the method and

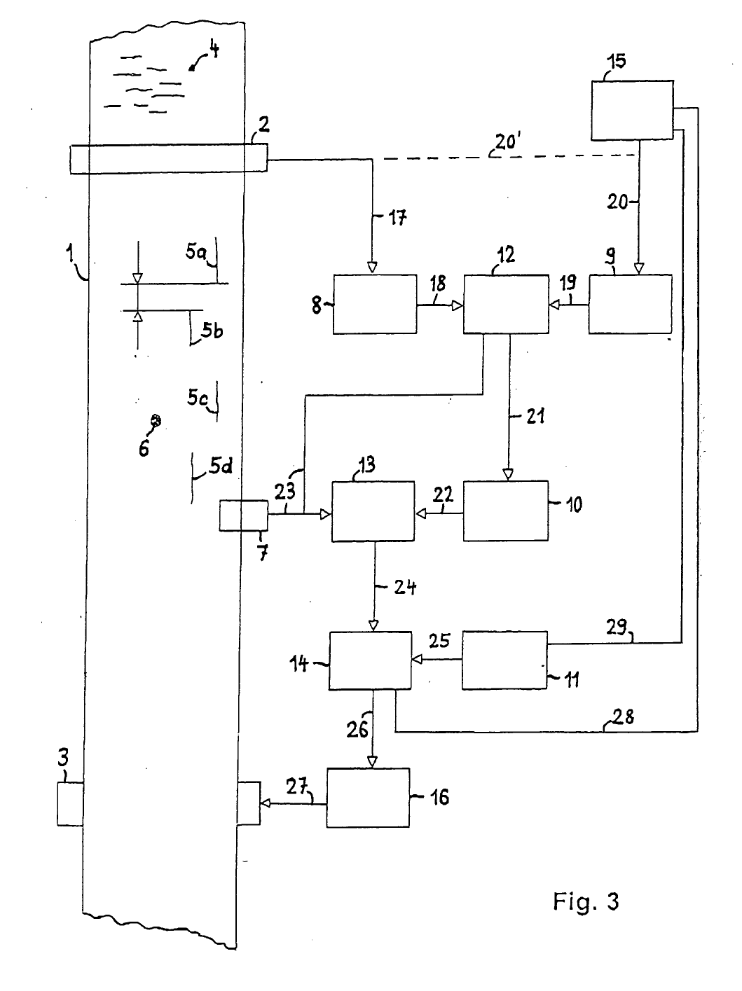

FIG. 3 shows a device suitable for carrying out the method.

FIG. 1 shows a coordinate system having three axes x, y and z, where the x axis and the y axis relate to the lengths by which a fabric under investigation extends. For example, the x axis may thus lie transversely with respect to the fabric and the y axis may specify the longitudinal direction of the fabric. The z axis is associated with one or more parameters such as intensity, contrast, colour etc. of the fabric. Thus, mass per unit length may be applied along the x and y axes and values for intensity, contrast, colour etc. may be applied along the z axis. The numeral 100 designates a field lying above the x/y plane spanned by the x and y axes. This field 100 indicates the level of the values of a parameter. Thus, for the spacing between the x/y plane and the field 100, it is the case that this spacing indicates the value of the parameter concerned. When a fabric of this kind is scanned by sensors in a manner known per se, lines are formed. In this illustration, some lines are designated n to n+4. Looked at precisely, these lines connect for example centre points 101, 102 of pixels 103, 104, here lying on the line 105, which means that lines 105 to 112 indicate values of pixels in a simplified illustration. 113 designates a row of values for the line n+4 or the line 110. It is apparent from the particular deflection of the lines 106-111 that these represent a particular feature, in the form of a hump in the field 100, discernible from the measured values along the lines 106-111. This particular feature can also be designated a fault 114. In the case of a woven fabric, the lines n may for example run in the direction of the weft threads or warp threads.

FIG. 2 shows the row of values 113 already familiar from FIG. 1 and comprising a series of scanned values 115, 116 etc. These are applied to a y axis along which values for a time or a path, for example, may be entered. Along the z axis values of electrical variables such as current, voltage etc. which are derived from the intensity, contrast or colour measured may be applied. Values for various parameters can be derived from the row of values 113. These could conceivably be in particular the length or duration 117 of a signal section 118, or parameters 119 derived from the scanned values, such as contrast, intensity, etc., which are proportional to the deflections in the row of values 113. For the parameters 117 and 119 limit values 120, 121 which serve to determine a fault in the fabric should also be predetermined. Here, the limit value 120 relates to directly measured values for the parameter 119, and the limit value 121 relates for example to a parameter 117 derived from the row of values 113, such as in this case the length or duration of the signal section 118, which is monitored by the predetermined limit value 121.

FIG. 3 shows a part of a textile fabric 1 which in this case is in the form of a material web and is moved in its longitudinal direction, as is the case for example when manufacturing on a loom or when winding from one roll to another when inspecting material, finishing, etc. Upstream or downstream of the fabric 1 there is provided a scanning device 2 which scans the fabric 1 which passes through in a manner known per se, for example optically. Provided for the fabric 1 there is a drive 3 which may for example comprise a driven roller or a pair or rolls. Various examples of possible faults are visible on the fabric 1, for example a cluster of faults 4, periodically occurring faults 5a, 5b, 5c, 5d and a fault 6 covering an area. A length measuring device 7 is also arranged along the fabric, comprising for example a wheel having a path encoder or an optical device. The length measuring device 7 may however also be integrated in the scanning device 2.

To process analog or digital signals from the scanning device 2, various memories 8, 9, 11, a counter 10, calculators 12, 13, 14, an input and output unit 15 and an actuator 16 are provided, and these are connected to one another and to the other elements by way of connections 17, 16, 19, 20, 21, 22, 23, 24, 25, 26, 27 and 28.

The invention operates as follows.

Preferably, before scanning of the fabric 1 starts, there must be a predetermination of what constitutes a fault and what does not. Thus, first of all parameters have to be selected which are to characterise faults, and limit values for the selected parameters have to be predetermined, the exceeding of which indicates faults in the fabric. Furthermore, for values of the selected parameters which exceed the limit values, value ranges which define categories for the faults must also be predetermined. Then, details of the permissible distribution of the faults and of actions to be triggered when the predetermined values are exceeded must also be predetermined. This can be done by manual input by way of the input/output unit 15. Some of the values may however also be fixed beforehand, that is to say these values are already permanently stored in the memories.

As the fabric 1 moved by the drive 3 is pulled past the scanning device 2, lines n, n+1, n+2, n+3, n+4, etc. (FIG. 1) are scanned for example line by line, with a row of values being produced for each line, such as the row of values 113 for the line n+4. These rows of values comprise scanned values such as the scanned values 115, 116, etc. (FIG. 2). These scanned values 115, 116, etc. have a deflection or value which may for example be measured as a current or voltage value. These scanned values 115, 116, etc. also represent physical variables such as brightness, contrast and intensity in the present context, however. They depend on which device or which measuring principle is used when the fabric 1 is scanned. These variables, and variables derived from them such as the length or duration of the signal section 118, are called parameters. Faults 4, 5, 6 (FIG. 3) in the fabric 1 are characterised by such parameters and their values. Thus, scanned values 115, 116, etc. are supplied to the memory 8 by way of the connection 17. The memory 8 is for example a FIFO memory and it in turn forms from the serially obtained values an image of part of the fabric 1, as shown in FIG. 1, in which the faults also appear through the values of their parameters. Stored in the memory 9 are limit values and all the details which can serve to allocate faults to a particular fault category within a group of fault categories, which will be described in more detail below. The calculator 12 receives current parameter values by way of the connection 18, and limit values against which the current parameter values are to be measured by way of the connection 19. By comparing the parameter values available to it with the predetermined limit values, it can allocate each fault to a category and supply an appropriate indication of the category determined to the counter 10 by way of the connection 21. In the counter 10, the faults in each category are counted by way of a reference length of the fabric 1 predetermined by the user, to determine whether there is a cluster. The scanned length is supplied from the length measuring device 7 to the calculators 12 and 13 by way of the connection 23. The calculator 13 calculates the number of faults per length, for example for each fault category, and supplies this number to the calculator 14 by way of the connection 24. This calculator 14 receives by way of the connection 25 a predetermined value from the memory 11, which has stored a permissible number of faults for each category, calculated per length of the fabric 1. This permissible number is supplied from the input/output unit 15 to the memory 11 by way of a connection 29 and stored there. The calculator 14 determines from the current number from the connection 24 and the predetermined number from the connection 25 whether the actuator 16 is to be alerted by way of the connection 26 to perform an action or whether information is merely to be output to the input/output unit by way of the connection 28. The types of information or action possible and how the categories are to be defined will be described below.

It is thus possible in accordance with the invention to predetermine by way of the input/output unit 15 the type of faults or fault categories which are dependent on and specifically predetermined by the type of textile fabric 1 present. For a woven fabric, the following fault categories are for example conceivable:
short warp faults
medium warp faults
long warp faults
short weft faults
medium weft faults
long weft faults
tight wefts
edge faults
partial weft faults
small area faults
medium area faults
large area faults

The user may also define their own fault categories, however, and input appropriate value ranges for the parameters.

For a knitted fabric, the fault categories could be the following:
holes
thin places
thick places
spots

For all these faults, values apply to the parameters defining the category concerned, such as:
location
dimension
average brightness, intensity or contrast
   and these are also input by way of the input/output unit 15 and allocated to the selected categories.

The parameters stored temporarily in the memory 8 are compared in the calculator 12 with predetermined values for these parameters from the memory 9 which define categories, and are in this way allocated to categories. For example, as a parameter the length of a fault in the weft direction may be predetermined, with for example 0.5 cm, 3 cm and 10 cm being predetermined values. If the measured length of the weft fault is larger than 10 cm, then it goes into the “long weft fault” category; if its length is between 3 and 10 cm it goes into the “medium weft fault” category; and if its length is between 0.5 and 3 cm it falls into the “short weft fault” category.

In addition to the categories mentioned above of a first type, determined by the properties of the faults, categories, of another type may also be predetermined or defined which characterise the distribution of faults on the fabric 1. Examples which may be given of this other type of categories are:
individual faults which occur without any discernible pattern, or faults which the user wants to have indicated on their very first occurrence,
periodic faults which occur at regular intervals, and
clusters of faults which comprise accumulations of faults in a locally delimited area and which comprise individual faults which, taken by themselves, might be tolerable.

In this connection, a minimum number of faults should be input by way of the input/output unit 15 for example for periodic faults, after which regularly occurring faults are to be considered periodic.

For a cluster of faults, once again the number of faults should be input by way of the input/output unit 15. The number of faults in this case relates to a minimum number per reference length of the fabric 1 after which the faults are to be considered a cluster of faults. It is possible to select the value ranges of the individual parameters individually for definition of the categories and the distribution.

Once the fault categories of the first type, which are input as fixed values beforehand in the form of the value ranges associated therewith, have been defined from suitable inputs, the device in accordance with FIG. 1 determines the categories of the other type, which are defined by the distribution of faults determined. In turn, the device determines from both categories the actions to be performed. For this, the properties of the faults and the distribution of faults are processed in the calculator 14 in accordance with a predetermined program and an action is defined as a result of this. Examples which may be given of actions are:
counting
triggering an alarm
stopping the drive
ignoring
marking.

The calculator 14 may convey counted faults to the input/output unit by way of the connection 28 for display. This may also apply with an alarm. If the drive 3 is to be stopped, a corresponding signal is passed by way of the connection 26 to the actuator 16 and by way of the connection 27 to the drive 3.

For the parameters, the user can input by way of the input/output unit 15 values for any conceivable fabric which predetermine categories of the first type which seem important to them. It is, however, also possible, instead of inputting them directly, to input parameters by deriving them from the signals from the scanning device 2, in that for example measured values are output by way of the connection 20′ to the input/output unit 15 and the memory 9 and these measured values are allocated to a category by way of the input/output unit 15.

The elements illustrated in the figure such as memories, calculators, etc. may be grouped into function blocks of a data processing program. However, they may also take the form of individual fixed blocks of a circuit for signal processing.

The method described above may also be illustrated in the table reproduced below. Here, in this example, only one parameter is mentioned, defined by value ranges. It would however also be possible to list other parameters defined by other values or ranges. A fault category is always defined by a combination of preferably a plurality of parameters with value ranges for each parameter.

| | Parameter | | Action | | |
|---|---|---|---|---|---|
| Fault category | Value range | | Individual | Cluster | Periodic |
| Warp fault: | | | | | |
| short | 0.5-3 | cm | − | ! | □ |
| average | 3-10 | cm | + | + | ! |
| long | >10 | cm | □ | □ | □ |
| Weft fault: | | | | | |
| short | 0.5-3 | cm | − | + | ! |
| average | 3-10 | cm | + | + | ! |
| long | >10 | cm | + | ! | ! |
| Partial weft | Weft fault > 3 cm | | + | + | ! |
| | adjacent to edge | | | | |
| Tight weft | ¾ fabric width > 3 | | □ | □ | □ |
| | weft threads | | | | |
| Edge fault | In weft direction | | + | □ | □ |
| Area fault | | | | | |
| small | dia <3 | cm | + | ! | □ |
| average | dia 3-10 | cm | + | ! | □ |
| large | dia >10 | cm | + | ! | □ |

Actions:
+ = count,
! = sound alarm,
□ = stop drive,
− = ignore

1. A method of processing signals obtained from scanning textile fabrics, wherein values for preselected parameters are derived from the signals,
limit values which serve to determine faults in the fabric are predetermined for the values of the parameters,
value ranges which define categories of faults in the fabric are determined for the values of the parameters, the distribution of faults in the fabric is determined for categories of fault in the fabric, and, as a function of the category determined and the distribution of the faults in the fabric, an action is performed in connection with the fabric.

2. A method according to claim 1, wherein said action on the fabric is selected from a group including counting the faults, disregarding the faults, stopping a drive for the fabric, marking the faults and triggering an alarm.

3. A method according to claim 1, wherein said categories of faults in the fabric are determined from a group including warp faults, weft faults, area faults and edge faults.

4. A method according to claim 1, wherein said parameters are derived from a group including at least length, width, contrast, intensity, diameter, and direction.
